(19) United States
(12) Patent Application Publication
(10) Pub. No.: US 2007/0022478 A1
(43) Pub. Date: Jan. 25, 2007

(54) Information processing apparatus and method of ensuring security thereof

(75) Inventors: Kotaro Miyamoto, Tokyo (JP); Shuji Hori, Iruma-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/529,238

(22) Filed: Sep. 29, 2006

Related U.S. Application Data
(63) Continuation of application No. PCT/JP05/05269, filed on Mar. 23, 2005.

(30) Foreign Application Priority Data
Mar. 31, 2004 (JP) 2004-108046

(51) Int. Cl. H04L 9/32; G06F 12/14; H04L 9/00; G06K 9/00; G06F 17/30; H04K 1/00; G06F 12/00; G06F 7/04; G06F 13/00; G06F 7/58; G06K 19/00; G11C 7/00

(52) U.S. Cl. 726/17; 726/2; 713/182

(57) ABSTRACT

An information processing apparatus according to the present invention includes the following: an input portion; authenticating means for performing authentication processing using authentication information input from the input portion and registered authentication information; a memory portion for storing authentication failure information when the result of the authentication processing performed by the authenticating means is failure; and a display portion for displaying the stored authentication failure information when the result of the authentication processing performed by the authenticating means is success. According to the above-described configuration, useful information for security management can be provided, as well as, a deterrent effect against unauthorized access can be raised.

### CROSS-REFERENCE TO RELATED APPLICATION

This application is based upon and claims the benefit of priority from PCT application No. PCT/JP2005/005269 filed Mar. 23, 2005 and Japanese Patent Application No. 2004-108046, filed Mar. 31, 2004, the entire contents of which are incorporated herein by reference.

### BACKGROUND

1. Field

The present invention relates to information processing apparatuses and methods of ensuring security thereof and, more particularly, to an information processing apparatus for recording and displaying an authentication operation failure history and a method of ensuring security thereof.

2. Description of the Related Art

Currently, information processing apparatuses including personal computers are widely used in society, and an environment that allows information processing apparatuses to be accessed by anyone, anywhere, and at anytime has been improved.

In addition, the proliferation of networking among information processing apparatuses has naturally facilitated data sharing by means of a LAN or the like.

In such an information-oriented society, security techniques for preventing the falsification and leakage of data by eliminating unauthorized use of information processing apparatuses have been increasingly become important.

As one of the security techniques for eliminating unauthorized use of information processing apparatuses, there is a password authentication technique.

Now, many information processing apparatuses require users to enter a password when they are started up. When the password entered by a user does not match the password registered in advance, the start-up sequence of the information processing apparatus cannot proceed. Alternatively, many information processing apparatuses are configured to be shut down when password authentication fails a plurality of times.

The password authentication is generally performed at the operating system level (hereinafter abbreviated as OS). However, techniques for performing password authentication at the BIOS level have also been disclosed (see, for example, JP-A 2003-108256 and JP-A 2001-27911).

Since the password authentication at the BIOS level does not depend on the type of an OS or the presence of an OS, it can certainly not only prohibit use of application software but also eliminate unauthorized use of information processing apparatuses for the purpose of copying or deleting data.

However, known information processing apparatuses using password authentication or the like merely provide means for preventing users from obtaining unauthorized access thereto.

On the other hand, whether unauthorized access to a specific information processing apparatus has occurred becomes a very important fact in terms of security management.

Even if a person that accessed an information processing apparatus for the purpose of unauthorized use has failed to use it or copy data stored therein, the fact that such unauthorized access was attempted is useful information for reviewing a security management method or system.

If information processing apparatuses can provide unauthorized access history information, for example, information about whether unauthorized access thereto occurred, as well as, in the case where unauthorized access occurred, information about when the unauthorized access occurred and, if possible, information about who accessed thereto for the purpose of unauthorized use, this function of information processing apparatuses can be useful for security management and can further greatly serve as a deterrent against unauthorized access.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an exemplary external view of an information processing apparatus according to a first embodiment of the present invention.

FIG. 2 is a diagram showing an exemplary basic configuration of an information processing apparatus according to the first embodiment of the present invention.

FIG. 3 is a diagram showing a start-up sequence of a known information processing apparatus.

FIG. 4 is a diagram showing components for BIOS start-up processing in an information processing apparatus according to the first embodiment of the present invention.

FIG. 5 is a diagram showing a procedure of the BIOS start-up processing in an information processing apparatus according to the first embodiment of the present invention.

FIG. 6 is a diagram showing a procedure of BIOS start-up processing in an information processing apparatus according to a second embodiment of the present invention.

FIG. 7 is a diagram showing components for BIOS start-up processing in an information processing apparatus according to a third embodiment of the present invention.

### DETAILED DESCRIPTION

An information processing apparatus according to the present invention, a method of starting the information processing apparatus, and a program for starting the information processing apparatus will be described with reference to the accompanying drawings.

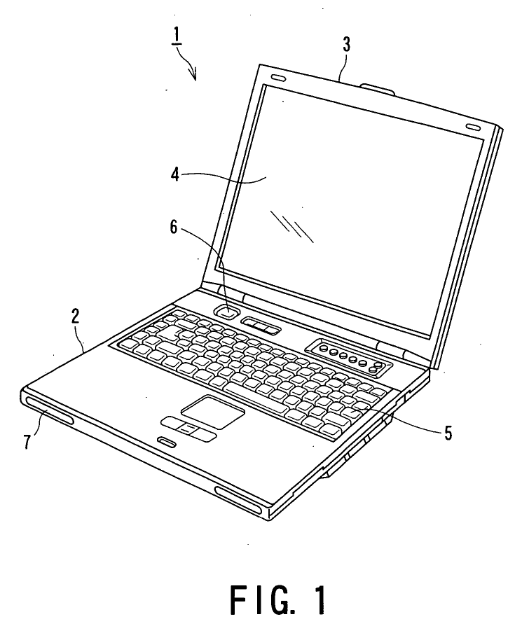

FIG. 1 is a diagram showing an exemplary external view of an information processing apparatus 1 according to a first embodiment of the present invention.

The information processing apparatus 1, for example, a personal computer, is provided with a thin and rectangular main unit 2, and a panel portion 3 openably and closably connected to the main unit 2.

A display portion 4 configured with, for example, an LCD is disposed on the inner surface of the panel portion 3.

A keyboard 5, a power switch 6, etc. used for inputting various information are disposed on the upper surface of the main unit 2.

A speaker 7 for generating an alarm intended for alerting an operator and sound conveying information is disposed on the front side surface of the main unit 2.

The size and shape of the information processing apparatus 1 are not limited to those shown in FIG. 1, and the arrangement, size, and shape of components such as the display portion 4 and the keyboard 5 are not limited to those shown in FIG. 1. Some components shown in FIG. 1 may not be provided.

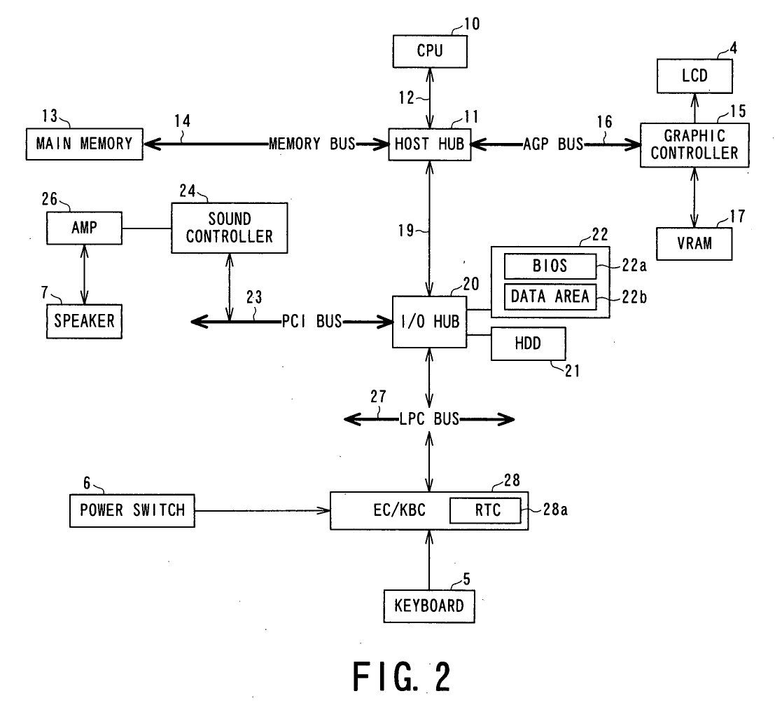

FIG. 2 is a diagram showing a system configuration of the information processing apparatus 1 according to the first embodiment of the present invention.

A CPU (Central Processing Unit) 10 is connected to a host hub 11 via a CPU bus 12. The host hub 11 is connected to a device that is required to rapidly perform processing. More specifically, the host hub 11 is connected to a main memory 13 via a memory bus 14 and to a graphic controller 15 via, for example, an AGP (Accelerated Graphic Port) bus 16. The host hub 11 is provided with a memory controller for controlling access to the main memory 13.

The CPU 10 serves as a processor provided so as to control operations of the information processing apparatus 1. The CPU 10 executes an operating system (OS) and various application/utility programs loaded from a hard disk drive (HDD) 21 via the memory bus 14 to the main memory 13, as well as, a BIOS (Basic Input/Output System) 22a stored in a BIOS-ROM 22.

The graphic controller 15 performs display on an LCD 4 on the basis of data that has been drawn in a video memory 17 in accordance with the OS and an application program.

The host hub 11 is connected to an I/O hub 20 via a bus 19 such as a hub interface.

The I/O hub 20 is connected to, for example, the HDD 21 that serves as an external memory, and the BIOS-ROM 22 that serves as a nonvolatile memory.

The I/O hub 20 is also connected to a PCI (Peripheral Components Interconnect) bus 23. The PCI bus 23 is connected to various devices compliant with a PCI bus standard, for example, a sound controller 24 shown in FIG. 2. The sound controller 24 is connected to a speaker 7 via an AMP (amplifier) 26.

The I/O hub 20 is connected to an LPC (Low Pin Count) bus 27 whose speed is relatively low. The LPC bus 27 is connected to, for example, an EC/KBC (Embedded Controller/KeyBoard Controller) 28 that serves as an embedded type processor. The EC/KBC 28 is connected to a keyboard 5 and a power switch 6.

Power is supplied to the EC/KBC 28 by a battery or the like even if the information processing apparatus 1 is in a power-off state. Therefore, upon detecting that the power switch 6 has been pressed, the EC/KBC 28 can start a start-up sequence of the information processing apparatus 1.

Since the EC/KBC 28 is provided with an RTC (Real Time Clock) 28a, even if the information processing apparatus 1 is in the power-off state, the current time can be always updated.

The BIOS-ROM 22 configured with, for example, a flash memory stores a program called BIOS 22a.

The BIOS 22a is started when the information processing apparatus 1 is turned on. The BIOS 22a is different from programs such as the OS and application software stored in an external memory such as the HDD 21, and therefore can set system settings of the information processing apparatus 1 by performing a predetermined operation when the information processing apparatus 1 is turned on.

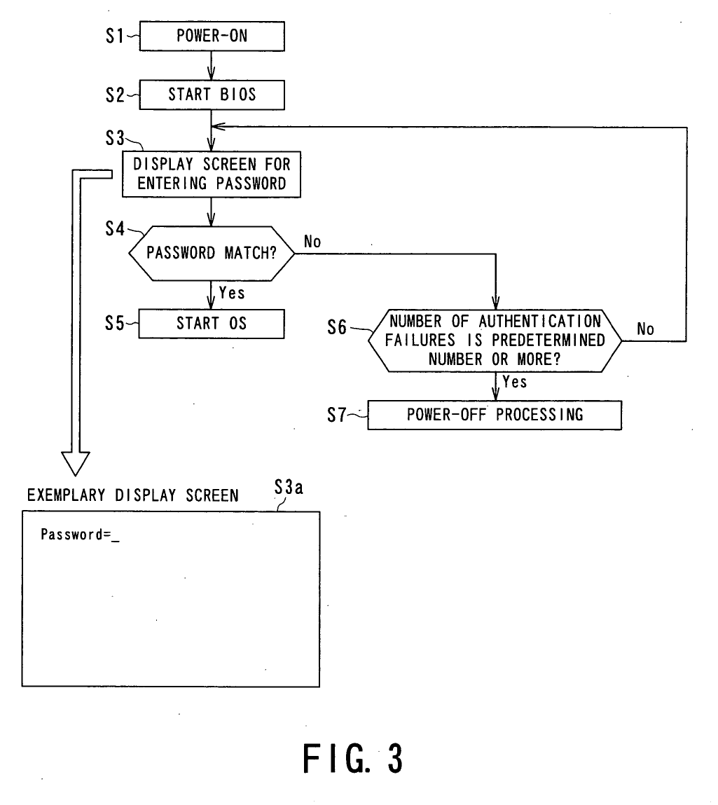

FIG. 3 is a flow chart showing a procedure of a known start-up sequence of the information processing apparatus 1 such as a personal computer. The known start-up sequence will be described with reference to FIGS. 2 and 3.

First, when an operator presses the power switch 6, the EC/KBC 28 detects the operation by the operator and provides power to each portion of the information processing apparatus 1 (step S1 in FIG. 3).

Next, the BIOS 22a is started (S2). One of the main functions of the BIOS 22a is a control operation of an input/output function provided to the information processing apparatus 1. Therefore, when the BIOS 22a is started, a key entry operation by means of an input portion such as the keyboard 5 is enabled. In addition, the display portion 4 becomes operable as an output function.

The BIOS 22a includes a function capable of registering, in advance, authentication information such as a password as means for ensuring security. The authentication information is stored in, for example, a data area 22b included in the BIOS-ROM 22 that serves as a nonvolatile memory.

When a password has been registered in advance, the BIOS 22a displays a screen S3a for entering a password on the display portion 4 (S3).

When the password entered by the operator matches the password registered in advance (yes in S4), the OS is started (S5).

After the OS has been started, the operator can start application software such as document composition software as appropriate.

On the other hand, when the password entered by the operator does not match the password registered in advance, that is, authentication fails (no in S4), the screen S3a for entering a password is displayed again. Consequently an operation for entering a password is repeated (S6 and S3).

However, when the number of authentication failures reaches a predetermined number (yes in S6), it is considered that unauthorized access has been attempted, whereby power-off processing is performed (S7).

When a password has not been registered in the BIOS 22a in advance, the OS is immediately started after S3 and S4 are skipped. Therefore, in this case, the screen S3a for entering a password is not displayed.

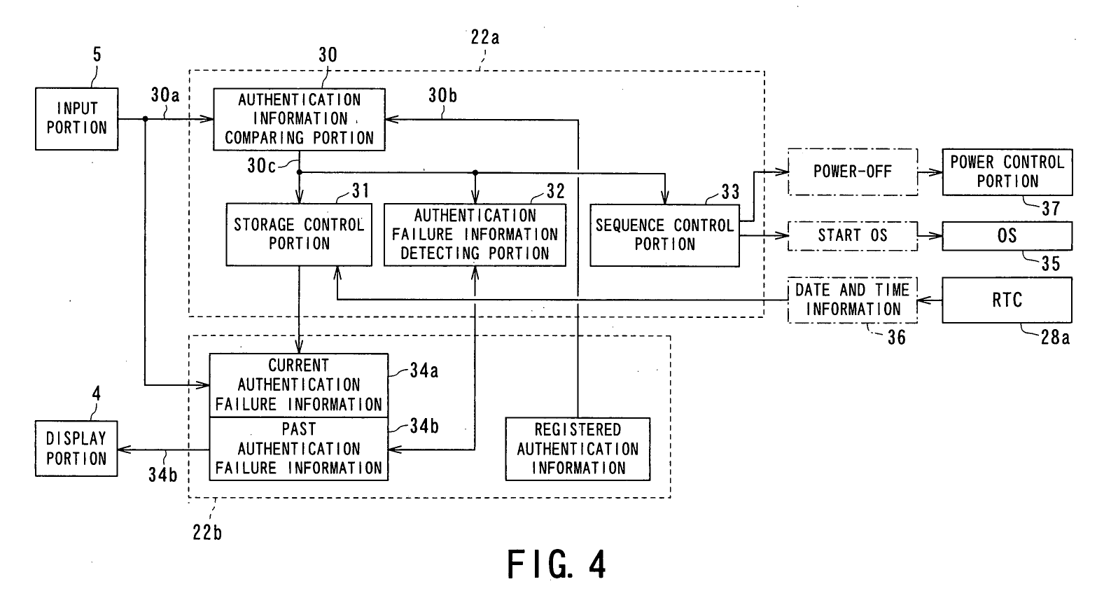

FIG. 4 is a diagram showing a system configuration regarding the start-up of the information processing apparatus 1 according to an embodiment of the present invention.

The BIOS 22a is configured with the following components: an authentication information comparing portion (authenticating means) 30; a storage control portion 31; an authentication failure information detecting portion (detecting means or a detecting portion) 32; a sequence control portion 33; etc.

Authentication information 30a is input from an input portion 5. Authentication failure information 34b is displayed on the display portion 4.

A start-up instruction is output from the sequence control portion 33 to an OS 35. Date and time information 36 is input into the storage control portion 31.

Functions of individual portions will be described.

The input portion 5 serves as the keyboard 5 for entering the authentication information 30a such as a password.

An authentication method of eliminating unauthorized access is not limited to the method in which a password is used, and may be token authentication that uses a token such as a USB key, and may be biometrics authentication such as fingerprint authentication. In this case, the input portion 5 becomes a USB connector or a fingerprint input portion.

The authentication information comparing portion 30 compares the authentication information 30a having been input from the input portion 5 with registered authentication information 30b having been stored in advance in a memory portion 22b, and then outputs a comparison result 30c.

The comparison result 30c shows either authentication success information in the case where the authentication information 30a corresponds exactly to the registered authentication information 30b, or authentication failure information in the case where the authentication information 30a does not correspond to the registered authentication information 30b.

When the comparison result 30c shows the authentication failure information, the storage control portion 31 causes the date and time information (year/month/day/hour/minute/second) 36 corresponding to when the authentication information 30a was input from the input portion 5 to be stored in the area for storing current authentication failure information 34a in the memory portion 22b. When the comparison result 30c shows the authentication failure information, the storage control portion 31 may cause not only the date and time information 36 corresponding to when the authentication information 30a was input from the input portion 5 but also the authentication information 30a to be stored in the area for storing current authentication failure information 34a in the memory portion 22b.

As the date and time information (year/month/day/hour/minute/second) 36, for example, information on the RTC 28a included in the EC/KBC 28 shown in FIG. 2 is used.

The current authentication failure information 34a is transferred to the area for storing past authentication failure information 34b in the memory portion 22b, for example, during power-off.

The authentication failure information detecting portion 32 checks whether data exists in the area for storing the past authentication failure information 34b when the comparison result 30c shows authentication success information. When the past authentication failure information 34b is stored, the date and time information (year/month/day/hour/minute/second) 36 thereof corresponding to when the authentication failed is displayed on the display portion 4.

The sequence control portion 33 outputs an instruction for starting the OS 35 when the comparison result 30c shows the authentication success information. On the other hand, the sequence control portion 33 outputs an instruction for power-off processing to a power control portion 37 when the comparison result 30c shows the authentication failure information.

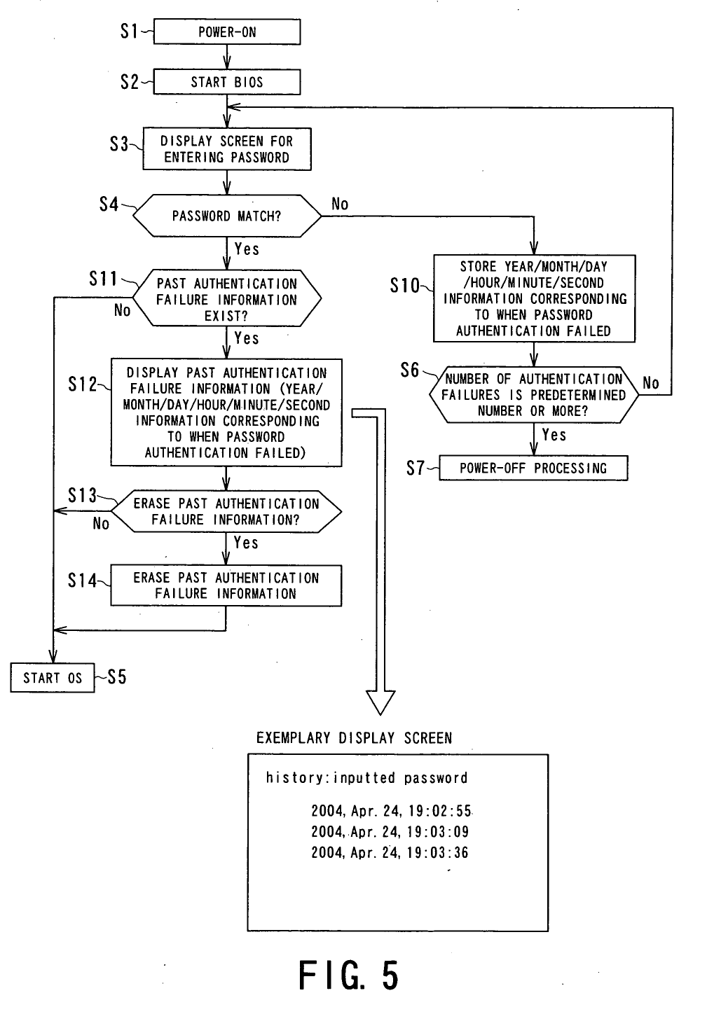

FIG. 5 is a flowchart showing a procedure of start-up processing of the information processing apparatus 1 according to an embodiment of the present invention.

Since a procedure from S1 to S3 is same as that shown in FIG. 3, the description thereof will be omitted.

In step 4 (S4), it is determined whether the authentication information 30a such as a password corresponds to the registered authentication information 30b. When the authentication information 30a does not correspond to the registered authentication information 30b, that is, authentication has failed (no in S4), authentication failure information (date and time information (year/month/day/hour/minute/second) corresponding to when authentication failed) is stored in the memory portion (S10).

Next, it is determined whether the number of authentication failures is a predetermined number or more (S6). In a case where the predetermined number of authentication failures is set to three, when authentication has failed three times (yes in S6), power-off processing is performed (S7).

On the other hand, when the number of authentication failures is less than the predetermined number (no in S6), a screen for entering a password is displayed again (S3).

When authentication is successful (yes in S4), the operator can be regarded as an authorized operator. In this case, it is further determined whether the past authentication failure information 34b is stored so as to check whether unauthorized access has been attempted (S11).

When the past authentication failure information 34b is not stored, it can be considered that unauthorized access to the information processing apparatus 1 has not been attempted. In this case (no in S11), the OS is started as usual (S5).

On the other hand, when the past authentication failure information 34b is stored (yes in S11), it can be considered that unauthorized access to the information processing apparatus 1 has been attempted. In this case, the past authentication failure information 34b (for example, data and time information corresponding to when the authentication failed) is displayed on the display portion 4 (S12).

At this time, in order to alert the operator, an audible alarm may be generated by, for example, the speaker (sound generating portion) 7 disposed in the information processing apparatus 1.

Consequently, the authorized operator can realize that unauthorized access to the information processing apparatus 1 has been attempted. In addition, the authorized operator can be aware of date and time information such as year/month/day/hour/minute/second information corresponding to when the unauthorized access was attempted.

The determination as to whether the past authentication failure information 34b is erased is performed by causing the operator to enter a specific key using the keyboard 5 (S13). When it is determined that the past authentication failure information 34b is to be erased, the past authentication failure information 34b is erased (S14).

When it is obvious that the past authentication failure information 34b is due to the fact that the authorized operator made a mistake, the display of the past authentication failure information 34b becomes not only meaningless but also complicated. Accordingly, the operator erases the past authentication failure information 34b, whereby the display of the past authentication failure information 34b can be skipped next time.

Using the information processing apparatus 1 according to the present invention, an authorized operator can realize that unauthorized access to the information processing apparatus 1 has been attempted, as well as, be aware or data and time information, for example, year/month/day/hour/minute/second information corresponding to when the unauthorized access was attempted.

Using the acquired unauthorized access information, a security manager can review and improve a security management method and a security management system.

In addition, the function capable of easily obtaining the unauthorized access information can be expected to serve as a deterrent against unauthorized access, that is, unauthorized access can be prevented.

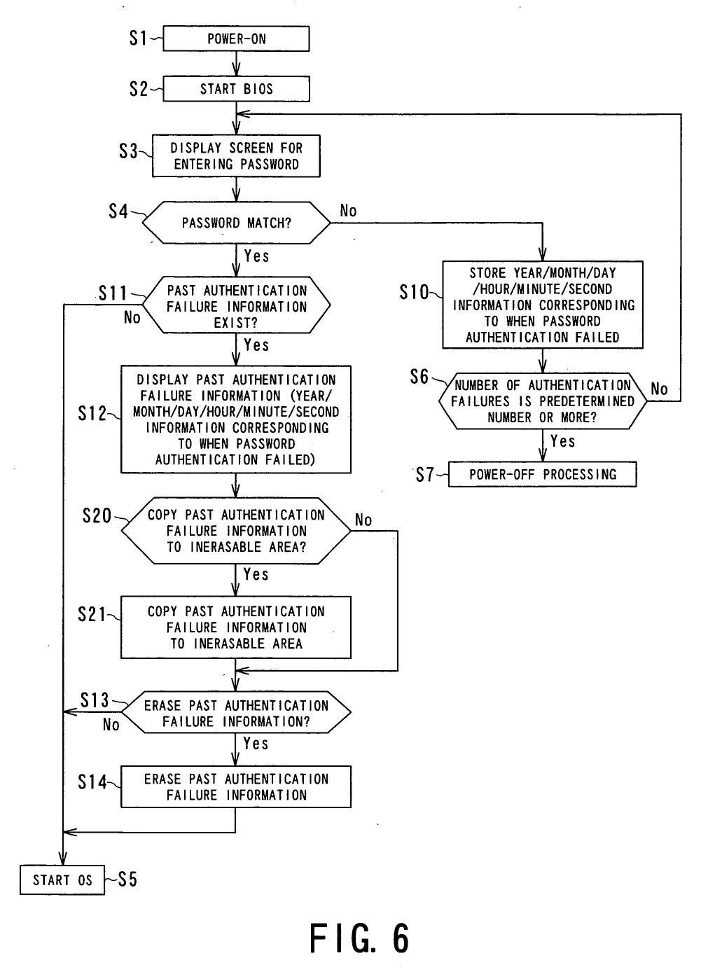

FIG. 6 is a diagram showing a procedure of start-up processing of the information processing apparatus 1 according to a second embodiment of the present invention.

The difference between the procedure of processing in a first embodiment (the procedure shown in FIG. 5) and the procedure shown in FIG. 6 is that steps 20 (S20) and 21 (S21) are added.

It is determined whether the past authentication failure information 34b is to be copied to an inerasable area (S20). This determination is performed in accordance with a specific key information input from, for example, the keyboard 5.

In step 20, when it is determined that the past authentication failure information 34b is to be copied to the inerasable area, the past authentication failure information 34b is copied to the inerasable area (S21).

Consequently, even if it is determined in steps 13 and 14 that the past authentication failure information 34b is not required and it is then erased, the past authentication failure information 34b can be read out if needed.

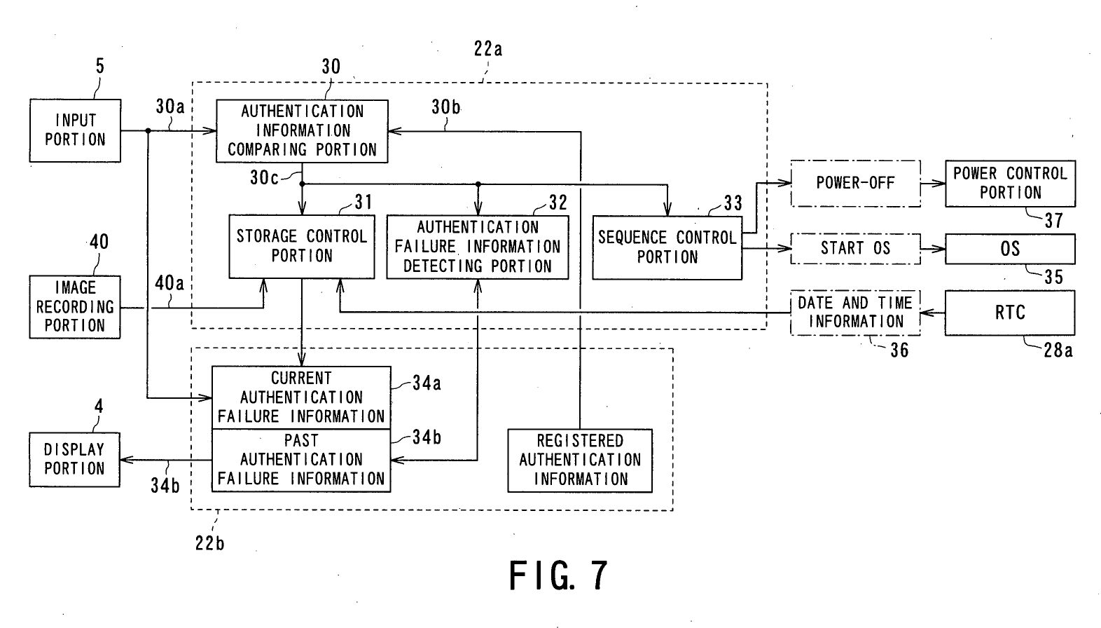

FIG. 7 is a diagram showing components of the information processing apparatus 1 according to a third embodiment of the present invention.

The information processing apparatus 1 according to the third embodiment is provided with a video recording portion (image pickup portion) 40.

The video recording portion 40 is configured so that a camera lens portion thereof disposed on the upper surface of the main unit 2 of the information processing apparatus or on the upper end of the panel portion 3 can record images such as, the face of an operator. The video recording portion 40 is used for recording image information and for videophones over the Internet, etc.

In the third embodiment of the present invention, when authentication has failed in the authentication information comparing portion 30, image information 40a and the date and time information 36 are stored in the memory portion 22b as the current authentication failure information 34a.

Accordingly, the current authentication failure information 34a includes date and time information (year/month/day/hour/minute/second) corresponding to when authentication failed and the image information 40a such as the image of the face of a person that attempted to perform unauthorized access, the image having been recorded by the video recording portion 40.

By using the current authentication failure information 34a, more effective security management can be achieved. In addition, a deterrent effect against unauthorized access can be further raised.

The present invention is not limited to the above-described embodiments, and various modifications may be made without departing from the scope and spirit of the present invention when it is practiced. Various inventions can be extracted by appropriately combining a plurality of constituent elements disclosed in the above-described embodiments. For example, some of all constituent elements described in the embodiments may be omitted. Furthermore, the constituent elements disclosed in different embodiments may be appropriately combined.

### INDUSTRIAL APPLICABILITY

By using an information processing apparatus according to the present invention and a method of ensuring security thereof, useful information for security management can be provided, as well as, a deterrent effect against unauthorized access can be raised.

What is claimed is:

1. An information processing apparatus, comprising:
an input portion;
authenticating means for performing authentication processing using authentication information input from the input portion and registered authentication information;
a memory portion for storing authentication failure information when the result of the authentication processing performed by the authenticating means is failure; and
a display portion for displaying the stored authentication failure information when the result of the authentication processing performed by the authenticating means is success.

2. The information processing apparatus according to claim 1, further comprising an operating system, the operating system being started after the stored authentication failure information is displayed on the display portion.

3. The information processing apparatus according to claim 1, further comprising a power control portion for turning off the information processing apparatus when the result of the authentication processing performed by the authenticating means is failure a predetermined number of times.

4. The information processing apparatus according to claim 1, further comprising an operating system, and wherein the authentication information is input from the input portion after the information processing apparatus is turned on, as well as, before the operating system is started.

5. The information processing apparatus according to claim 1, wherein the authentication failure information includes date and time information corresponding to when the authentication information was input from the input portion.

6. The information processing apparatus according to claim 1, wherein an erasure instruction for erasing the stored authentication failure information can be input from the input portion.

7. The information processing apparatus according to claim 6, wherein, when the erasure instruction for erasing the authentication failure information is input from the input portion, the authentication failure information is erased after being copied to an inerasable area.

8. The information processing apparatus according to claim 1, further comprising a sound generating portion, the sound generating portion generating a sound when the result of the authentication processing performed by the authenticating means is failure.

9. The information processing apparatus according to claim 1, further comprising an image pickup portion, and wherein the authentication failure information includes information corresponding to an image picked up by the image pickup portion.

10. A method of ensuring security of an information processing apparatus, comprising the steps of:
performing authentication processing using authentication information input from an input portion and registered authentication information;
storing authentication failure information in a memory portion when the result of the authentication processing is failure; and
displaying the stored authentication failure information, on a display portion when the result of the authentication processing is success.

11. The method of ensuing security of an information processing apparatus according to claim 10, wherein an operating system is started after the stored authentication failure information is displayed on the display portion.

12. The method of ensuing security of an information processing apparatus according to claim 10, wherein the information processing apparatus is turned off when the result of the authentication processing is failure a predetermined number of times.

13. The method of ensuing security of an information processing apparatus according to claim 10, wherein the authentication information is input from the input portion after the information processing apparatus is turned on, as well as, before the operating system is started.

14. The method of ensuing security of an information processing apparatus according to claim 10, wherein the authentication failure information includes date and time information corresponding to when the authentication information was input from the input portion.

15. The method of ensuing security of an information processing apparatus according to claim 10, wherein an erasure instruction for erasing the stored authentication failure information can be input from the input portion.

16. The method of ensuing security of an information processing apparatus according to claim 10, wherein, when the erasure instruction for erasing the authentication failure information is input from the input portion, the authentication failure information is erased after being copied to an inerasable area.

17. The method of ensuing security of an information processing apparatus according to claim 10, wherein a sound generating portion generates a sound when the result of the authentication processing is failure.

18. The method of ensuing security of an information processing apparatus according to claim 10, wherein the authentication failure information includes information corresponding to an image picked up by an image pickup portion.
